(19) United States
(12) Patent Application Publication
(10) Pub. No.: US 2016/0217302 A1
(43) Pub. Date: Jul. 28, 2016

(54) HIGH-SPEED, HACKER-RESISTANT COMPUTER DATA STORAGE AND RETRIEVAL SYSTEM

(71) Applicant: Karim Kassam, AI-Rayyan City (QA)

(72) Inventor: Karim Kassam, AI-Rayyan City (QA)

(21) Appl. No.: 14/603,633

(22) Filed: Jan. 23, 2015

(51) Int. Cl. G06F 21/62; G06Q 20/38; G06Q 20/40; G06F 17/30

(52) U.S. Cl. CPC G06F 21/6254; G06F 17/3033; G06F 21/6227; G06Q 20/3827; G06Q 20/409; G06Q 2220/10

(57) ABSTRACT

According to one embodiment, a computer system includes one or more programmable processors configured to receive a first set of data, and generate a parent identifier for the first set of data. The programmable processors are also configured to shred the first set of data into a plurality of data elements, including a first data element and a second data element. The programmable processors are further configured to generate a first child identifier for the first data element based on the parent identifier and the first data element. The programmable processors are further configured to generate a first location number for the first data element based on the first data element, and transmit the first data element and the first child identifier for storage in a first database in a first location having the first location number.

### TECHNICAL FIELD

This disclosure relates generally to the field of data storage and more specifically to a high-speed, hacker-resistant computer data storage and retrieval system.

### BACKGROUND

Traditionally, data may be stored in a memory unit, disk on a server (e.g., in flat files or organized in some fashion), a database (e.g., Database Management Systems), or any other type of storage system(s). Furthermore, these storage systems are typically on a network for connectivity and accessibility. These typical network systems, however, may be susceptible to unauthorized access by internal and external users. For example, a person may hack into these typical network systems, gaining access to the data. In order to prevent such unauthorized access, network storage systems may traditionally be protected by security (such as firewalls, Intrusion Detection Systems/Intrusion Prevention Systems) and/or the data may traditionally be encrypted using any one of several encryption methods (all of which use encryption keys). Such traditional manners of protection, however, may be deficient as they may only require an unauthorized person to bypass the security and/or obtain a copy of the encryption key in order to access the data. Additionally, such traditional manners of protection may also allow an unauthorized user to access the data using some sort of brute force method(s) to break through the encryption, or use malware or Trojans to gain access to user authentication information and thus access the data from within the organization using elevated credentials.

### SUMMARY

According to one embodiment, a computer system includes one or more memory units configured to store one or more instructions, and one or more programmable processors coupled to the memory units. The programmable processors are configured, upon executing the one or more instructions, to receive a first set of data, and generate a parent identifier for the first set of data. The parent identifier is a unique identifier for the first set of data. The programmable processors are also configured to shred the first set of data into a plurality of data elements. The plurality of data elements include a first data element and a second data element. The programmable processors are further configured to generate a first child identifier for the first data element. The first child identifier is a unique identifier for the first data element, and is generated based on the parent identifier and the first data element. The programmable processors are further configured to generate a first location number for the first data element based on the first data element, and transmit the first data element and the first child identifier for storage in a first database in a first location having the first location number.

Certain embodiments of the disclosure may provide one or more technical advantages. For example, data to be stored may be shredded into data elements, and each of the data elements may be stored with a respective child identifier. In such an example, although each data element of a set of data may have a child identifier, there may not be any direct relationship between any of the child identifiers. Instead, the parent identifier (which is not stored) may provide the only connection between data elements of the same set of data. As such, even if the data elements are accessed through an unauthorized means (such as by hacking the data storage device, for example), the relationship between each of the data elements would remain obscured (e.g., all the hacker will see is scrambled data stored in isolation with no means of putting it all together to make it useful or of value), thereby providing additional security to the stored data. This may provide a computer system (and/or a computerized data storage system) that is more secure, and harder to hack (e.g., hacker resistant), in particular embodiments. Furthermore, this computer system may be capable of protecting the stored data even when an unauthorized user (such as a hacker) is able to break through the firewall or other traditional security systems (e.g., Intrusion Detection Systems/Intrusion Prevention Systems). Additionally, unlike traditional systems, this computer system may further protect the data (and may also allow an authorized user to access the stored data) without storing encryption keys, in particular embodiments. As such, an unauthorized user (such as a hacker) will not be able to improperly access the stored data by merely copying or stealing an encryption key. Also, in particular embodiments, the data elements may be stored in an encrypted manner, which may provide additional security to the stored data.

As another example, a child identifier may be generated for each data element, where the child identifier may uniquely identify the data element. In such an example, each data element may be transmitted for storage with the respective child identifier. Furthermore, the child identifier may operate as an index for the stored data element. As such, the data element may be more easily found in storage and retrieved. Furthermore, as a result of the child identifier uniquely identifying the data element, access time to the data element may be independent of the size of the data storage device, such as a database. Therefore, the data element may be accessed in substantially the same amount of time, no matter how many data elements are added to data storage device. In particular embodiments, this may allow for additional storage without requiring search times to be increased. As such, the computer system may be a high-speed computer system that may run faster (and retrieve stored data faster) even when larger amounts of data are stored. Additionally, due to this ability to run faster (and retrieve stored data faster), the computer system may not require as many hardware resources in order to enhance performance. Furthermore, in particular embodiments, because the child identifier is generated automatically for the data element, and may operate as an index for the data elements, the child identifiers may reduce the need for administration time to upkeep the index of the data storage device. Specifically, the ability of the child identifiers to operate as an index may cause the index to be continuously updated, and further cause the computer system to be less prone to index failures, in particular embodiments. As such, this computer system may need less administration time (or have less administration needs) due to less index failures.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1 illustrates an example system that allows data to be stored and/or retrieved;

FIG. 2a illustrates an example method of shredding data into data elements for storage;

FIG. 2b illustrates an example of data and data elements for storage;

FIG. 2c illustrates an example of a data entry form; and

FIG. 3 illustrates an example method of retrieving a requested data element from storage.

### DETAILED DESCRIPTION

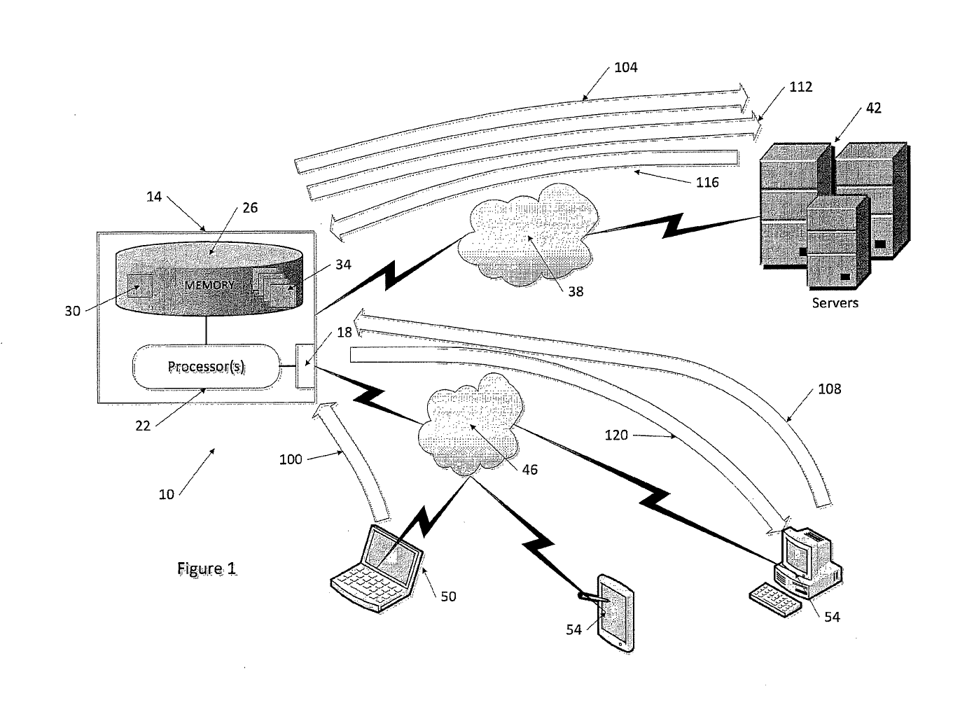

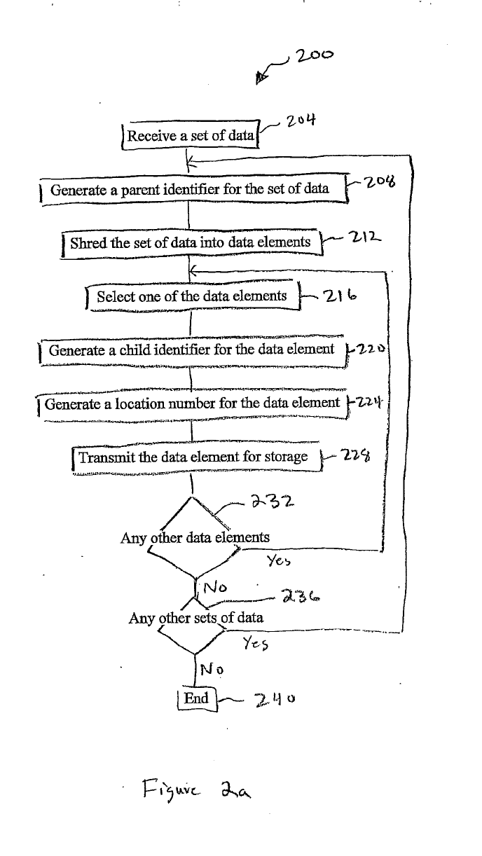

Embodiments of the present disclosure are best understood by referring to FIGS. 1-3 of the drawings, like numerals being used for like and corresponding parts of the various drawings.

FIG. 1 illustrates an example system 10 that allows data to be stored and/or retrieved. System 10 includes a data shredding device 14 that receives data, and shreds the data into data elements. System 10 further includes a data storage device 42 that stores the data elements, and further allows the data elements to be retrieved and re-assembled. In particular embodiments, by shredding the data into data elements and storing the data elements, the relationship between the data elements of the data may be encrypted. As such, in particular embodiments, even if all of the data elements are accessed by an unauthorized entity (such as by a person hacking into the data storage device 42), the relationship between the data elements of the data would still be unknown to the unauthorized entity. In particular embodiments, this may provide additional security for the data.

Data represents any type of information. For example, data may be financial information, medical information, security information, business information, customer information, client information, any other type of information, or any combination of the preceding. Data may further be any information that may be provided by a person (or an entity) when conducting a transaction and/or receiving a service. For example, data may be any information that may be provided by a person when purchasing a product or service over a communication network, such as the Internet (e.g., shipping address, payment information), information that may be provided by a person at a visit with a physician (e.g., ailments, medical history, medical data, lab results, etc.), any other information that may be provided by a person (or an entity) when conducting a transaction and/or receiving a service, or any combination of the preceding. Data may include personally identifiable information. For example, data may include a person's (or an entity's) name (e.g., first name, middle name, last name), contact information (e.g., phone number, address, electronic address), social security information, information about friends and family, financial information (e.g., credit card information, bank information, investment information), medical information (e.g., medical records, medical diagnosis, medical charts), any other personally identifiable information, or any combination of the preceding. Data may have any format. For example, data may be a number, a set of numbers, a word, a set of words, a spreadsheet, a document (such as a word document), a picture, an image, a fax, a text (such as a short message service text), any other format of information, or any combination of the preceding.

Traditionally, data may be stored in a memory unit, disk on a server (e.g., in flat files or organized in some fashion), a database (e.g., Database Management Systems), or any other type of storage system(s). Furthermore, these storage systems are typically on a network for connectivity and accessibility. These typical network systems, however, may be susceptible to unauthorized access by internal and external users. For example, a person may hack into these typical network systems, gaining access to the data. In order to prevent such unauthorized access, network storage systems may traditionally be protected by security (such as firewalls, Intrusion Detection Systems/Intrusion Prevention Systems) and/or the data may traditionally be encrypted using any one of several encryption methods (all of which use encryption keys). Such traditional manners of protection, however, may be deficient as they may only require an unauthorized person to bypass the security and/or obtain a copy of the encryption key in order to access the data. Additionally, such traditional manners of protection may also allow an unauthorized user to access the data using some sort of brute force method(s) to break through the encryption, or using malware or Trojans to gain access to user authentication information and thus access the data from within the organization using elevated credentials. As such, in particular embodiments, system 10 of FIG. 1 may provide various advantages.

For example, according to system 10, data to be stored may be shredded into data elements, and each of the data elements may be stored with a respective child identifier. In such an example, although each data element of a set of data may have a child identifier, there may not be any direct relationship between any of the child identifiers. Instead, the parent identifier (which is not stored) may provide the only connection between data elements of the same set of data. As such, even if the data elements are accessed through an unauthorized means (such as by hacking the data storage device 42, for example), the relationship between each of the data elements would remain obscured (e.g., all the hacker will see is scrambled data stored in isolation with no means of putting it all together to make it useful or of value), thereby providing additional security to the stored data. This may provide a computer system (and/or a computerized data storage system) that is more secure, and harder to hack (e.g., hacker resistant), in particular embodiments. Furthermore, this computer system may be capable of protecting the stored data even when an unauthorized user (such as a hacker) is able to break through the firewall or other traditional security systems (e.g., Intrusion Detection Systems/Intrusion Prevention Systems). Additionally, unlike traditional systems, this computer system may further protect the data (and may also allow an authorized user to access the stored data) without storing encryption keys, in particular embodiments. As such, an unauthorized user (such as a hacker) will not be able to improperly access the stored data by merely copying or stealing an encryption key. Also, in particular embodiments, the data elements may be stored in an encrypted manner, which may provide additional security to the stored data.

As another example, according to system 10, a child identifier may be generated for each data element, and the child identifier may uniquely identify the data element. In such an example, each data element may be transmitted for storage with the respective child identifier. Furthermore, the child identifier may operate as an index for the stored data element. As such, the data element may be more easily found in storage and retrieved. Furthermore, as a result of the child identifier uniquely identifying the data element, access time to the data element may be independent of the size of the data storage device or data repository, such as a database. Therefore, the data element may be accessed in substantially the same amount of time, no matter how many data elements are added to data storage device. In particular embodiments, this may allow for additional storage without requiring search times to be increased. As such, the computer system may be a high-speed computer system that may run faster (and retrieve stored data faster) even when larger amounts of data are stored. Additionally, due to this ability to run faster (and retrieve stored data faster), the computer system may not require as many hardware resources in order to enhance performance. Furthermore, in particular embodiments, because the child identifier is generated automatically for the data element, and may operate as an index for the data elements, the child identifiers may reduce the need for administration time to upkeep the index of the data storage device. Specifically, the ability of the child identifiers to operate as an index may cause the index to be continuously updated, and further cause the computer system to be less prone to index failures, in particular embodiments. As such, this computer system may need less administration time (or have less administration needs) due to less index failures.

As illustrated, system 10 includes data shredding device 14. Data shredding device 14 represents any suitable components that receive data, and shred the data into data elements. Data shredding device 14 may include a network server, any suitable remote server, a mainframe, a host computer, a workstation, a web server, a personal computer, a laptop, a mobile telephone (such as a Smartphone), an electronic notebook, a personal digital assistant, a file server, any other suitable device for receiving data, and shredding the data into data elements, or any combination of the preceding. Data shredding device 14 may also transmit the data elements to data storage device 42. Furthermore, data shredding device 14 may retrieve the data elements and re-assemble the data elements. The functions of data shredding device 14 may be performed by any suitable combination of one or more servers or other components at one or more locations. In an embodiment where the data shredding device 14 is a server, the server may be a private server, and the server may be a virtual or physical server. The server may include one or more servers at the same or remote locations. Also, data shredding device 14 may include any suitable component that functions as a server. As illustrated, data shredding device 14 includes a network interface 18, a processor 22, and a memory unit 26.

Network interface 18 represents any suitable device operable to receive information from network 38 (and/or networks 46), transmit information through network 38 (and/or networks 46), perform processing of information, communicate to other devices, or any combination of the preceding. For example, network interface 18 may receive data entered at data entry device 50 (and/or data access device 54) and communicated to network interface 18 over network 46. As another example, network interface 18 may communicate data elements to data storage device 42 over network 38. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows data shredding device 14 to exchange information with network 38, data storage device 42, network 46, data entry device 50, data access device 54, or other components of system 10.

Processor 22 communicatively couples to network interface 18 and memory unit 26, and controls the operation and administration of data shredding device 14 by processing information received from network interface 18 and memory unit 26. Processor 22 includes any hardware and/or software that operates to control and process information. For example, processor 22 executes data shredding device management application 30 to control the operation of data shredding device 14. Processor 22 may be a programmable logic device, one or more microcontrollers, one or more microprocessors, any suitable processing device, or any combination of the preceding.

Memory unit 26 stores, either permanently or temporarily, data, operational software, or other information for processor 22. Memory unit 26 includes any one or a combination of volatile or non-volatile local or remote devices suitable for storing information. For example, memory unit 26 may include random access memory (RAM), read only memory (ROM), magnetic storage devices, optical storage devices, any other suitable information storage device, or any combination of the preceding. Additionally, memory unit 26 may be an encrypted data storage device (or a data storage device secured in any manner), providing protection against fraudulent attempts to access the information stored in memory unit 26. While illustrated as including particular information modules, memory unit 26 may include any suitable information for use in the operation of data shredding device 14.

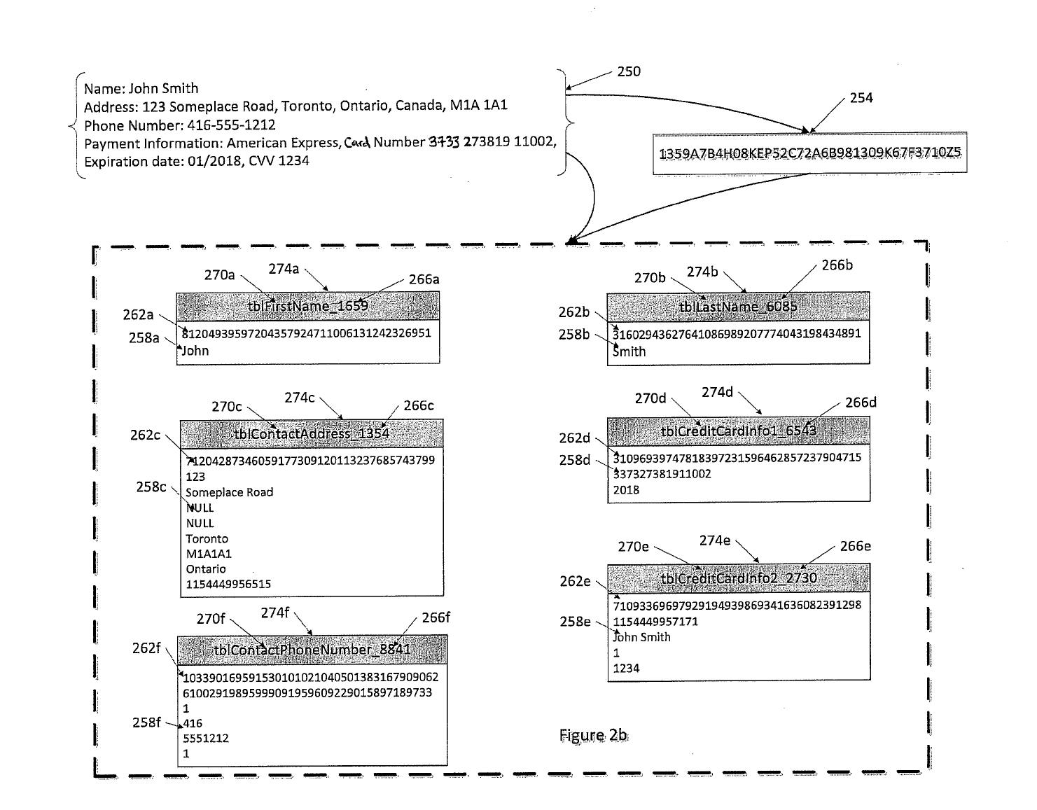

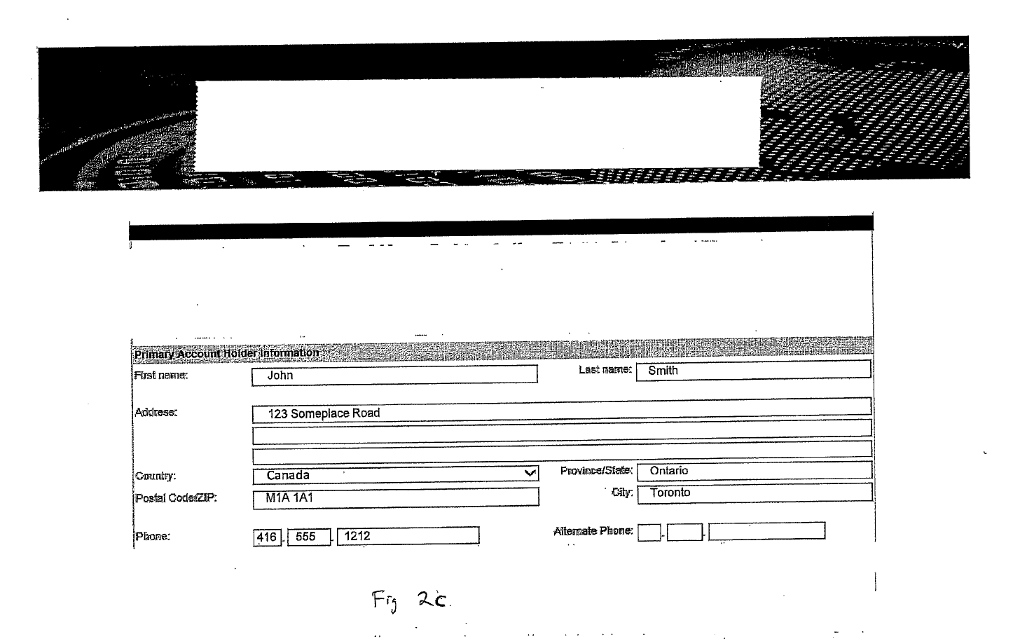

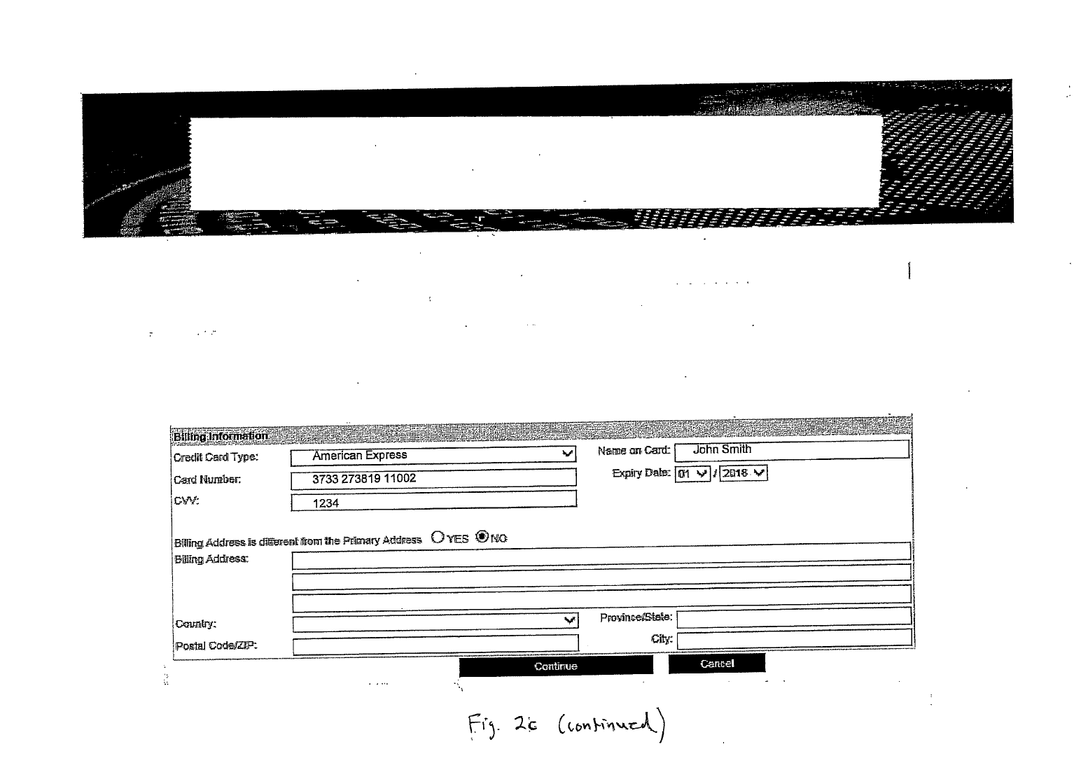

As illustrated, memory unit 26 includes data shredding device management application 30 and encryption methods 34. Data shredding device management application 30 represents any suitable set of instructions, logic, or code embodied in a computer-readable storage medium and operable to facilitate the operation of data shredding device 14. Encryption methods 34 represent any type of encryption method that may be utilized to generate parent identifiers (discussed in detail with regard to FIG. 2a), child identifiers (discussed in detail with regard to FIG. 2a), location numbers (discussed in detail with regard to FIG. 2a), any other information utilized in system 10, or any combination of the preceding. For example, an encryption method 34 may be a one-time pad (OTP), a globally unique identifier (GUID) generator, Advanced Encryption Standard (AES), International Data Encryption Algorithm (IDEA), Data Encryption Standard (DES), Triple Data Encryption Algorithm (Triple DES), Blowfish, Elliptic curve cryptography (ECC), any other method of encryption, or any combination of the preceding. Memory unit 26 may include any number of encryption methods 34. For example, memory unit 26 may include one encryption method 34, two encryption methods 34, three encryption methods 34, four encryption methods 34, five encryption methods 34, or any other number of encryption methods 34. In particular embodiments, memory unit 26 may include one or more encryption methods 34 for generating parent identifiers, one or more encryption methods 34 for generating child identifiers, and/or one or more encryption methods 34 for generating location numbers.

Network 38 represents any suitable network operable to facilitate communication between the components of system 10, such as data shredding device 14 and data storage device 42. Network 38 may include any interconnecting system capable of transmitting audio, video, signals, data, messages, or any combination of the preceding. Network 38 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components. In particular embodiments, network 38 may be a TCP/IP network, or any other communication protocol network. Furthermore, in particular embodiments, one or more of the communications (such as all of the communications) between data shredding device 14 and data storage device 42 may be encrypted (or otherwise secured in any suitable manner), providing protection against unauthorized attempts to access the information included in the communications.

Data storage device 42 represents any suitable components that store data elements. Data storage device 42 may include a network server, any suitable remote server, a mainframe, a host computer, a workstation, a web server, a personal computer, a file server, a storage area network (SAN), network available storage (NAS), a hard drive, a solid state drive (SSD) system, any other suitable device for storing data elements, or any combination of the preceding. The functions of data storage device 42 may be performed by any suitable combination of one or more servers or other components at one or more locations. In an embodiment where the data storage device 42 is a server, the server may be a private server, and the server may be a virtual or physical server. The server may include one or more servers at the same or remote locations. Also, data storage device 42 may include any suitable component that functions as a server. In particular embodiments, data storage device 42 may be (or may include) one or more databases for storing the data elements. For example, data storage device 42 may be (or include) an SQLServer, Oracle, DB2, MySQL, SQLBase, any other structured query language (SQL) compliant database, a flat file database, any other type of database, a flat file system, unstructured data, any type of file system(s) supported by available systems that are supported by servers, or any combination of the preceding. Furthermore, a data storage device 42 may be (or may include) more than one database, such as two databases, three databases, five databases, or any other number of databases. System 10 may include any number of data storage devices 42. For example, system 10 may include one data storage device 42, two data storage devices 42, three data storage devices 42, five data storage devices 42, ten data storage devices 42, twenty data storage devices 42, or any other number of data storage devices 42. Each data element (of the data) stored by the data storage device 42 may be stored in any one of the data storage devices 42. For example, if data is shredded into three data elements, the first data element may be stored in a first data storage device 42, the second data element may be stored in a second data storage device 42 (or in the first or a third data storage devices 42), and the third data element may be stored in a third data storage device 42 (or in the first or second data storage devices 42).

Network 46 represents any suitable network operable to facilitate communication between the components of system 10, such as data shredding device 14, data entry device 50, and/or data access device 54. Network 46 may include any interconnecting system capable of transmitting audio, video, signals, data, messages, or any combination of the preceding. Network 46 may include all or a portion of a PSTN, a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components. In particular embodiments, network 46 may be a TCP/IP network, or any other communication protocol network. Furthermore, in particular embodiments, one or more of the communications (such as all of the communications) between data shredding device 14, data entry device 50, and/or data access device 54 may be encrypted (or otherwise secured in any suitable manner), providing protection against unauthorized attempts to access the information included in the communications. Additionally, although network 46 and network 38 are illustrated as separate networks, network 46 and network 38 may be the same network. In such an example, a single network may communicate data to and/or from data entry device 50 and/or data access device 54, and may also communicate data elements to data storage device 42.

Data entry device 50 represents any suitable components that allow data to be entered and transmitted to data shredding device 14. For example, data entry device 50 may include a point-of-sale terminal, a personal computer, a workstation, a laptop, a mobile telephone (such as a Smartphone, or any other wireless, cellular, cordless, or satellite telephone), an electronic notebook, a personal digital assistant, a data entry kiosk, a scanner, any other device (wireless, wireline, or otherwise) that allows data to be entered and transmitted to data shredding device 14, or any combination of the preceding. Data entry device 50 may be associated with a customer. For example, a customer may wish to purchase one or more goods from a merchant. In order to do so, the customer may enter their name, contact information, and/or payment information into data entry device 50 (via an electronic form displayed on the data entry device 50, for example), causing the goods to be purchased. In particular embodiments, this information may be data that is transmitted to data shredding device 14. Data entry device 50 may be associated with a business. For example, a business (such as a merchant of goods, or a doctor's office) may have one or more employees (and/or devices) that enter information associated with the business, information associated with customers of the business, information associated with clients of the business, any other information collected and/or received by the business, any other information, or any combination of the preceding. In particular embodiments, this information may be data that is transmitted to data shredding device 14.

Data access device 54 represents any suitable components that allow data to be accessed. For example, data access device 54 may include a personal computer, a workstation, a laptop, a mobile telephone (such as a Smartphone, or any other wireless, cellular, cordless, or satellite telephone), an electronic notebook, a personal digital assistant, a data access kiosk, any other device (wireless, wireline, or otherwise) that allows data to be accessed and/or viewed, or any combination of the preceding. Data access device 54 may be associated with a business. For example, the business (such as a merchant of goods, or a doctor's office) may have entered (or received) data for storage in data storage device 42. An employee of the business (such as a doctor) may desire to view a portion of the data (such as the medical records of a patient). In order to do so, the employee may utilize data access device 54 to view the portion of the data. In particular embodiments, data access device 54 may access the data by sending a request to data shredding device 14, which may retrieve the data elements (for the data) from data storage device 42, re-assemble the data, and transmit the data to data access device 54.

In an exemplary embodiment of operation, a first user of system 10 may input a set of data that may be stored as data elements in data storage device 42. For example, a first user of system 10 may desire to purchase one or more goods from a business over the Internet. In order to do so, the first user may utilize the data entry device 50 in order to input the set of data. The set of data may be any information associated with purchasing the goods. For example, the set of data may be the first user's name (e.g., John Smith), the first user's address (e.g., 123 Someplace Road, Toronto, Ontario, Canada, M1A 1A1), the first user's phone number (e.g., 416-555-1212), the first user's e-mail address (e.g., js@mydomain.com), a login reminder for the first user (e.g., mother's maiden name=Martha), and/or payment information for the first user (e.g., American Express card number 3733 273819 11002 with an expiration date of 01/2018 and a CVV of 1234). After entering this set of data, the purchase may be confirmed, and the set of data may be transmitted to the data shredding device 14 (via one or more data entry transmissions 100).

The data shredding device 14 may receive the set of data from the data entry transmission(s) 100. In order to store the set of data, data shredding device 14 may shred the set of data into data elements. Following the shredding of the set of data into data elements, the data shredding device 14 may transmit the data elements for storage in one or more data storage device 42 (via one or more storage transmissions 104). The data storage device 42 may receive the storage transmission(s) 104, and may store the data elements based on the storage transmission(s) 104. An example of the shredding of the set of data into data elements, the transmission of data elements for storage, and the storage of the data elements is discussed below with regard to FIG. 2a.

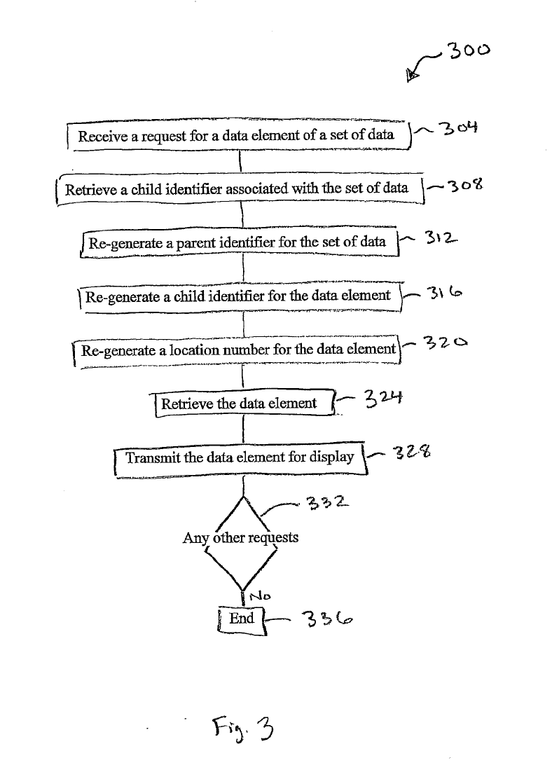

Following the storage of the data elements, a second user of system 10 may desire to view the set of data. For example, the second user may be an employee of the merchant who is checking to confirm the address of the first user prior to shipping the goods. In order to do so, the second user may send a request for the first set of data of the first user (via one or more data access requests 108). Based on the data access request(s) 108, the data shredding device 14 may transmit one or more data retrieval requests 112 to the data storage device 42 to request the data elements. In particular embodiments, the data retrieval requests 112 may allow the set of data to be retrieved. In response, the data storage device 42 may search for the requested data elements and transmit the data elements to the data shredding device 14 via one or more data responses 116. Furthermore, the data shredding device 14 may re-assemble the set of data and transmit the set of data to the data access device (for view by the second user) via one or more results messages 120. An example of the retrieval of the data elements and re-assembly of the set of data is discussed below with regard to FIG. 3.

Modifications, additions, or omissions may be made to system 10 without departing from the scope of the invention. For example, data shredding device 14 may shred and/or retrieve any number of sets of data, such as two sets of data, three sets of data, five sets of data, ten sets of data, one hundred sets of data, one thousand sets of data, one million sets of data, ten million sets of data, or any other number of sets of data. As a further example, system 10 may utilize any number of data entry transmissions 100, storage transmissions 104, data access requests 108, data retrieval requests 112, data responses 116, and/or results messages 120, and the data entry transmissions 100, storage transmissions 104, data access requests 108, data retrieval requests 112, data responses 116, and/or results messages 120 may be performed in parallel with other steps, or in any suitable order. As another example, system 10 may include any number of data shredding devices 14, networks 38, data storage devices 42, networks 46, data entry devices 50, and/or data access devices 54 (and/or any number of components, such as processors or memory units illustrated in the above described devices). Also, any suitable logic may perform the functions of system 10 and the components and/or devices within system 10.

Furthermore, one or more components of system 10 may be combined and/or eliminated. For example, although data shredding device 14 and data storage device 42 are illustrated as being separate devices, data shredding device 14 and data storage device 42 may be the same device. In such an example, the single device may shred the data, store the data, retrieve the data, and re-assemble the data. As another example, although data shredding device 14 and data entry device 50 (and/or data access device 54) are illustrated as being separate devices, data shredding device 14 and data entry device 50 (and/or data access device 54) may be the same device. In such an example, the single device may shred the data, and may further allow a user to input the data and/or access the data. As another example, although data entry device 50 and data access device 54 are illustrated as being separate devices, data entry device 50 and data access device 54 may be the same device. In such an example, the single device may allow a user to input the data and/or access the data.

FIG. 2a illustrates an example method of shredding data into data elements for storage. In particular embodiments, one or more steps of method 200 may be performed by shredding device 14 of FIG. 1. Furthermore, one or more steps of method 200 may be (or may be performed in response to) one or more of data entry transmissions 100 and/or storage transmissions 104 of FIG. 1.

The method 200 begins at step 204, where a set of data is received. The set of data may represent any type of information, as is discussed above. For example, the set of data may be financial information, medical information, security information, business information, customer information, client information, any other type of information, or any combination of the preceding. The set of data may further be any information that may be provided by a person (or an entity) when conducting a transaction and/or receiving a service. For example, the set of data may be any information that may be provided by a person when purchasing a product or service over a communication network, such as the Internet (e.g., shipping address, payment information), information that may be provided by a person at a visit with a physician (e.g., ailments, medical history), any other any information that may be provided by a person (or an entity) when conducting a transaction and/or receiving a service, or any combination of the preceding. The set of data may include personally identifiable information. For example, the set of data may include a person's (or an entity's) name (e.g., first name, middle name, last name), contact information (e.g., phone number, address, electronic address), social security information, information about friends and family, financial information (e.g., credit card information, bank information, investment information), medical information (e.g., medical records, medical diagnosis, medical charts), any other personally identifiable information, or any combination of the preceding. The set of data may include any amount of information. For example, the set of data may be one piece of information, two pieces of information, three pieces of information, four pieces of information, or any other number of pieces of information. An example of a set of data is illustrated in FIG. 2b as set of data 250.

The set of data may be received in any manner. For example, the set of data may be entered or input into one or more data entry devices 50, which may then transmit the set of data to the data shredding device 14. As another example, the set of data may be entered or input into the data shredding device 14 directly. In such examples, the set of data may be entered into a digital (or paper) form, such as, for example, the form shown in FIG. 2c. As another example, the set of data may be retrieved from a document or record (such as a financial document or a medical record). For example, a document or record may be scanned, and the set of data may be retrieved from the document or record using, for example, optical character recognition. As a further example, the set of data may be retrieved from a database or any other storage device. The set of data may be received for any reason. For example, the set of data may be received when a customer enters the information to purchase one or more goods over, for example, the Internet. As another example, the set of data may be received when an employee enters the information as a result of a customer purchasing one or more services, such as when the customer visits a doctor's office.

At step 208, a parent identifier for the set of data is generated. A parent identifier (or permanent identifier) may be a unique identifier for the set of data. For example, the parent identifier may be a globally unique identifier that is generated for only a single set of data. In such an example, if a first set of data is received for a first customer (e.g., John Smith) and a second set of data is received for a second customer (e.g., Jane Smith), each set of data will a unique identifiers (e.g., the first set of data for John Smith will have a unique identifier and the second set of data for Jane Smith will have a different unique identifier). The parent identifier may be any unique identifier for a set of data. For example, the parent identifier may be a set of numbers, a set of letters (e.g., A, B, C, etc.), a set numbers and letters, a set of symbols (e.g., %, !, ?, etc.), a code, any other grouping of characters, or any combination of the preceding. The parent identifier may have any length. For example, the parent identifier may be a 38 character identifier, a 64 character identifier, an identifier with a length between 38 characters and 64 characters, or an identifier with any other length. An example of a parent identifier is illustrated in FIG. 2b as parent identifier 254.

The parent identifier may be generated in any manner. In particular embodiments, the parent identifier may be generated using one or more encryption methods 34. For example, the parent identifier may be generated using a OTP, a GUID generator, AES, IDEA, DES, Triple DES, Blowfish, ECC, any other method of encryption, or any combination of the preceding. The parent identifier may be used to generate one or more child identifiers, as is discussed below. As such, the parent identifier may provide the relationship between each child identifier, and thus the relationship between each data element of the shredded data. Although the parent identifier may be used to generate one or more child identifiers, in particular embodiments, it may not be stored. For example, once the parent identifier is generated, it may only be used to generate the child identifiers. After this is accomplished, the parent identifier may be overwritten, deleted, or otherwise not stored in the data shredding device 14, the data storage device 42, any of the other components of system 10, or any other location. In particular embodiments, because the parent identifier is not stored, it may not be accessed by any unauthorized attempts (such as a hack or an unauthorized access of the data shredding device 14). As such, the stored data may be more secure.

At step 212, the set of data may be shred into one or more data elements. A data element may be any portion of the first set of data. For example, a data element may be one piece of information of the first set of data, two pieces of information of the first set of data, three pieces of information of the first set of data, four pieces of information of the first set of data, or any other number of pieces of information of the first set of data. Examples of data elements are illustrated in FIG. 2c as data elements 258. The set of data may be shred into any number of data elements. For example, the set of data may be shred into two data elements, three data elements, four data elements, five data elements, ten data elements, twenty data elements, or any other number of data elements.

In one embodiment, a first data element of the first set of data (such as the first set of data 250) may include the first name “John” and a second data element may include the last name “Smith.” A data element may be any other portion of the first set of data. For example, instead of a data element being a full first name “John”, a first data element may be “J”, a second data element may be “o”, a third data element may be “h”, and a fourth data element may be “n”. As another example, instead of two data elements for the payment information of John Smith (as is illustrated by data elements 258d and 258e), the payment information may be shredded into, for example, ten or more data elements. In such an example, each digit of John Smith's credit card number may be shredded into a separate data element, for example.

At step 216, one of the data elements is selected. Following selection of one of the data elements, a child identifier is generated for the selected data element at step 220. A child identifier (or calculated identifier) may be a unique identifier for the data element. For example, the child identifier may be a globally unique identifier that is generated for only a single data element. In such an example, if a first data element (of a first set of data, for example) is “John”, and a second data element (of a second set of data, for example) is also “John”, each data element will have a unique identifier despite having the same data element. The child identifier may be any unique identifier for a data element. For example, the child identifier may be a set of numbers, a set of letters (e.g., A, B, C, etc.), a set of numbers and letters, a set of symbols (e.g., %, !, ?, etc.), a code, any other grouping of characters, or any combination of the preceding. The child identifier may have any length. For example, the child identifier may be a 38 character identifier, a 64 character identifier, an identifier with a length between 38 characters and 64 characters, or an identifier with any other length. Examples of a child identifier are illustrated in FIG. 2b as child identifiers 262.

The child identifier may be generated in any manner. In particular embodiments, the child identifier may be generated using one or more encryption methods 34. For example, the child identifier may be generated using a OTP, a GUID generator, AES, IDEA, DES, Triple DES, Blowfish, ECC, any other method of encryption, or any combination of the preceding. In particular embodiments, the child identifier may be generated using the same one or more encryptions methods 34 as the parent identifier, or using a different one or more encryption methods 34. The child identifier may be generated based on the parent identifier for the set of data and based on the data element (such as based on the data element itself, the data type of the data element, any other piece of information associated with the data element, or any combination of the preceding). For example, if the parent identifier is a 38 character identifier (as is seen in FIG. 2b as parent identifier 254) and the first name data element “John” has a data type of “first name”, the child identifier may be generated based on that 38 character identifier and the data type “first name”. In particular embodiments, the parent identifier for the set of data and the data type for the data element (and/or any other information associated with the data element) may be used with the one or more encryption methods 34 to generate the child identifier. For example, the parent identifier and the data type may be variables that are plugged into (or otherwise used with) the one or more encryption methods 34. In particular embodiments, although each data element of a set of data may have a child identifier, there may not be any direct relationship between any of the child identifiers of the set of data. Instead, the parent identifier (which is not stored) may provide the only connection between data elements of the same set of data. In particular embodiments, this may prevent anyone who accesses the data elements through an unauthorized manner (such as by hacking) from being able to understand (or piece together) the relationship between each data element. For example, if the unauthorized user was able to access a first name data element, a last name data element, an address data element, a first payment information data element, and a second payment information data element, the inability to understand the relationship between each data element may cause the unauthorized user to access the first name data element of a first set of data, such as for “John Smith”, the last name data element of a second set of data, such as for “Jane Doe”, the address data element for a third set of data, such as for “Jill Smith”, the first payment information data element for a fourth set of data, such as for “April Smith”, and the second payment information data element for a fifth set of data, such as for “Adam Doe”, rendering all of the accessed data unintelligible and useless to the unauthorized user. As such, the stored data may be more secure.

At step 224, a location number is generated for the data element. A location number may be an identifier of a location in which the data element will be stored. For example, when the data element is stored in a table in a database, the location number may be a number for the table in the database. In particular embodiments, the location number may not be unique. For example, data elements for different sets of data may be stored at the same location, such as the same table in a database. In such an example, if a first data element (of a first set of data, for example) is “John”, and a second data element (of a second set of data, for example) is “Jill”, both data elements may be stored in the same location, such as the same table in a database. Furthermore, in such an example, each data element may be indexed in the location by its child identifier. As such, even though “John” and “Jill” may be stored in the same table in the same database, “John” may be differentiated from “Jill” by its child identifier. The location number may be any identifier for a location in which the data element will be stored. For example, the location number may be a set of numbers, a set of letters (e.g., A, B, C, etc.), a set of numbers and letters, a set of symbols (e.g., %, !, ?, etc.), a code, any other grouping of characters, or any combination of the preceding. The location number may have any length. For example, the location number may be a 4 character number, a 6 character number, or a number with any other length. Examples of a location number are illustrated in FIG. 2b as location numbers 266.

The location number may be generated in any manner. In particular embodiments, the location number may be generated using one or more encryption methods 34. For example, the location number may be generated using a OTP, a GUID generator, AES, IDEA, DES, Triple DES, Blowfish, ECC, any other method of encryption, or any combination of the preceding. In particular embodiments, the location number may be generated using the same one or more encryptions methods 34 as the parent identifier and/or the child identifier, or using a different one or more encryption methods 34. The location number may be generated based on the data element (such as based on the data element itself, the data type of the data element, any other piece of information associated with the data element, or any combination of the preceding). For example, if the data element has a data type of “first name”, the location number may be generated based on the data type “first name”. In particular embodiments, the location number may be further (or alternatively) generated based on the data element itself. For example, if the data element is the first name “John”, the location number may be generated based on “John”. As another example, if the data element is the first name “John” and is a data type of “first name”, the location number may be generated based on both “John” and the data type “first name”. In particular embodiments, the location number may be generated based on the parent identifier for the set of data and based on the data element (such as based on the data element itself, the data type of the data element, any other piece of information associated with the data element, or any combination of the preceding). For example, if the parent identifier is a 38 character identifier (as is seen in FIG. 2b as parent identifier 254) and the first name data element “John” has a data type of “first name”, the location number may be generated based on that 38 character identifier and the data type “first name” In another embodiment, the location number may be generated based on the child identifier for the data element and based on the data element (such as based on the data element itself, the data type of the data element, any other piece of information associated with the data element, or any combination of the preceding). In particular embodiments, the data element, the data type (and/or any other information associated with the data element), or any other information (such as the parent identifier) may be used with the one or more encryption methods 34 to generate the location number. For example, the data element, the data type, and/or any other information may be variables that are plugged into (or otherwise used with) the one or more encryption methods 34.

The location number may be associated with a location name. A location name may be an additional identifier of a location in which the data element will be stored. For example, when the data element is stored in a table in a database, the location name may be a name for the table in the database. The location name may be any identifier for a location in which the data element will be stored. For example, the location number may be a set of numbers, a set of letters (e.g., A, B, C, etc.), a set of numbers and letters, a set of symbols (e.g., %, !, ?, etc.), a code, any other grouping of characters, or any combination of the preceding. In particular embodiments, the location name may be associated with a data type of the data element. For example, if the data element has a data type of “first name”, the location name may be, for example, “tblFirstName_”. Examples of a location name are illustrated in FIG. 2b as location names 270. The location name (and/or the data type of a data element) may be derived from the reception of the set of data. For example, as is discussed above, the set of data may be entered (by a customer or employee, for example) into a digital form, such as the form shown in FIG. 2c. Each of the data entry boxes in the form may be associated with a particular data type and/or location name. For example, the first name box of the form may be associated with the data type of, for example “first name” and/or the location name of, for example, “tblFirstName_”. As such, if data is entered into the first name box, the data element(s) for that data may be automatically assigned the data type of, for example, “first name” and/or the location name of, for example, “tblFirstName_”. As is discussed above, the location number may be associated with a location name. For example, a data element may be stored in a location (such as a table, for example) that has both a location name and a location number, such as the location name “tblFirstName_” and the location number “1659” (as illustrated in FIG. 2b as location number 266). The combination of both the location name and the location number may identify the location in which the data element is stored.

At step 228, the data element is transmitted for storage. The data element may be transmitted for storage in any manner. For example, one or more commands may be generated for the data element and sent to the data storage device 42. In such an example, following reception of the commands, the data storage device 42 may store the data element based on instructions in the commands. The commands may be any type of command, such as an SQL command, any other command for storing a data element, or any combination of the preceding. The command (such as an SQL command) may include any type of information. For example, the command may include the data element, the child identifier, the location number, the location name, any other information, or any combination of the preceding.

Following reception of the command, the data storage device 42 may use the command to store the data element. For example, if the data storage device 42 receives a command that instructs the data storage device 42 to store the data element “John” and the child identifier “81204939597204357924711006131242326951” in a location that has a location name “tblFirstName_” and a location number “1659”, the data storage device 42 may store the data element “John” and the child identifier “81204939597204357924711006131242326951” in the “tblFirstName_1659” location. Examples of locations (and the stored data elements and child identifiers) are illustrated in FIG. 2b as tables 274. Each location (such as a table) may store any number of data elements (and child identifiers). For example, each location may store one data element, two data elements, three data elements, four data elements, five data elements, ten data elements, one hundred data elements, one thousand data elements, ten thousand data elements, or any other number of elements (and child identifiers). Each of the data elements stored in a location may also be from different sets of data. For example, if a first data element (of a first set of data, for example) is “John”, and a second data element (of a second set of data, for example) is “Jill”, both data elements may be stored in the same location, such as the same table in a database. Furthermore, in such an example, each data element may be indexed in the location by its child identifier. As such, even though “John” and “Jill” may be stored in the same table in the same database, “John” may be differentiated from “Jill” by its child identifier.

The data element may be stored in any location in data storage device 42. For example, if data storage device 42 is (or includes) a database, a data element may be stored in any table in the database of the data storage device 42. Additionally, all of the data elements may be stored in the same data storage device 42 or one or more of the data elements may be stored in different data storage devices 42. For example, if the data storage devices 42 are (or include) databases, a first data element of a first set of data may be stored in a first database of a first data storage device 42, while a second data element (of a first set of data, or of a second set of data) may be stored in a second database of a second data storage device 42 (or even of the same first data storage device 42). As such, the data elements may be stored in locations that are spread over any number of data storage devices 42.

Additionally, although the data elements (or other information) are illustrated as being stored in an unencrypted manner, the data elements and/or other information may be stored (and transmitted to and/or from the data storage device 42) in an encrypted manner. For example, instead of a data element “John” being stored (and transmitted to and/or from the data storage device 42) as “John”, the data element may be encrypted into any code or set of characters, such as, for example, “%1xk&n̂”. As another example, location names (such as “tblFirstName_”) and/or location numbers (such as “0301”) may also be encrypted into any code or set of characters, such as, for example, “H1SF8BW45PAQ”. The data elements, location names, and/or location numbers may be encrypted in any manner, such as using one or more of encryption methods 34. In particular embodiments, the data elements, location names, and/or location numbers may be encrypted and unencrypted by, for example, the data shredding device 14. In particular embodiments, such additional encryption may provide additional security to the stored data.

Following transmission of the data element for storage, the method 200 may move to step 232 where it is determined whether there are any other data elements. If there are more data elements, method 200 may move back to step 216, and steps 216-228 may be repeated for each data element. If there are not any more data elements, method 200 may move to step 236, where it is determined whether there are any other sets of data. If there are more sets of data, method 200 may move back up to step 208, and steps 208-232 may be repeated for each set of data. If there are not any more sets of data, method 200 may move to step 240, where method 200 ends.

Modifications, additions, or omissions may be made to method 200. For example, although the steps of method 200 are described above as being performed by data shredding device 14, in particular embodiments, one or more of the steps of method 200 may be performed by any other device. Additionally, the steps of method 200 may be performed in parallel or in any suitable order.

FIG. 3 illustrates an example method of retrieving a requested data element from storage. In particular embodiments, one or more steps of method 300 may be performed by shredding device 14 of FIG. 1. Furthermore, one or more steps of method 300 may be (or may be performed in response to) one or more of data access requests 108, data retrieval requests 112, data responses 116, and/or results messages 120 of FIG. 1.

The method 300 begins at step 304, where a request for a data element of a set of data is received. The request for a data element may include a request for a data element of any set of data. For example, the request may include a request for a data element from any of the sets of data (and/or any of the types of data) discussed above with regard to FIGS. 1-2. The request for a data element may also include a request for any one or more data elements associated with a set of data. For example, the request may include a request for any of the data elements that the set of data was shredded into. An example of a request for a data element may be a request for the address associated with the data for John Smith.

The request may be received in any manner. For example, the request may be entered or input into one or more data access devices 54, which may then transmit the request to the data shredding device 14. As another example, the request may be entered or input into the data shredding device 14 directly. The request may be entered into a digital (or paper) form. For example, a digital form may include entry sections similar to those seen in the form shown in FIG. 2c. In such an example, a data requestor may input the first name “John” into the first name entry section and may also input the last name “Smith” into the last name entry section. Furthermore, the data requestor may select a section of the data that is being requested, such as, for example, the address. The request may also be entered in a query statement format, for example.

At step 308, a child identifier associated with the set of data is retrieved. The child identifier retrieved may be any of the child identifiers associated with the set of data. For example, the child identifier may be any of the child identifiers for any of the data elements of the set of data. In particular embodiments, the child identifier retrieved may be a child identifier further associated with the request. For example, if the data requestor requested the address associated with the data for John Smith, the child identifier retrieved may be the child identifier for the data element “John” and/or the data element “Smith”, for example.

The child identifier may be retrieved in any manner. In particular embodiments, in order to retrieve the child identifier, the data shredding device 14 may first obtain one or more location numbers (and/or location names) associated with the request. The location numbers (and/or location names) may be obtained in any manner. As one example, the location numbers (and/or location names) may be obtained by re-generating the location numbers (and/or location names). In such an example, the location numbers (and/or location names) may be re-generated in a manner similar to step 224 of FIG. 2a discussed above. Furthermore, if the data requestor requested the address associated with the data for John Smith, the data shredding device 14 may re-generate the location numbers (and/or the location names) for the first name data element “John” and/or the last name data element “Smith”, for example. As another example, the location numbers (and/or location names) may be obtained by transmitting a command (such as a SQL command) to the data storage device 42 for one or more location numbers (and/or location names) associated with the request. For example, if the data requestor requested the address associated with the data for John Smith, the data shredding device 14 may transmit a command (such as a SQL command) to the data storage device 42 for the location numbers (and/or location names) for the first name data element “John” and/or the last name data element “Smith”, for example. In such an example, the data storage device 42 may search for the results (and re-transmit the results) of such a command by searching for all location numbers (and/or location names) associated with all first name data elements “John” and all last name data elements “Smith”, for example.

Following the obtainment of the one or more location numbers (and/or location names) associated with the request, the data shredding device 14 may transmit a command (such as a SQL command) to the data storage device 42 for the child identifiers associated with the request. For example, the data shredding device 14 may transmit a command (such as an SQL command) to the data storage device 42 for the child identifiers for the first name data element “John” and the last name data element “Smith” stored at the location numbers (and/or location numbers), for example. The data storage device 42 may search for the results (and re-transmit the results) of such a command by searching (using the location numbers and/or location names) for all child identifiers with the first name data element “John”, and all child identifiers with the last name data element “Smith”, for example. At step 312, a parent identifier for the set of data is re-generated. The parent identifier for the set of data may be re-generated in any manner. For example, the parent identifier for the set of data may be re-generated based on the retrieved child identifiers. Furthermore, the parent identifier for the set of data may be re-generated in a manner that is opposite of step 220 of FIG. 2a above (e.g., generation of a child identifier). For example, opposite of step 220 of FIG. 2a, the parent identifier for the set of data may be re-generated based on the child identifier for the data element and further based on the data element (such as based on the data type of the data element, and/or any other information associated with the data element). For example, if the child identifier is a 38 character identifier and the data element has a data type of “last name”, the parent identifier may be generated based on that 38 character identifier and the data type “last name.” In particular embodiments, the child identifier for the data element and the data type (and/or any other information associated with the data element) may be used with the one or more encryption methods 34 to re-generate the parent identifier. For example, the child identifier and the data type may be variables that are plugged into (or otherwise used with) the one or more encryption methods 34.

In one embodiment, the parent identifier may be re-generated for each of the child identifiers that were obtained. For example, the parent identifier may be re-generated for the child identifier obtained for the first name data element “John” and the last name data element “Smith”. In particular embodiments, if the same parent identifier is re-generated for two data elements, then both of those data elements are part of the same set of data. For example, if the same parent identifier is re-generated for the first name data element “John” and the last name data element “Smith”, then both of those data elements are part of the same set of data for “John Smith.” In particular embodiments, if different parent identifiers are re-generated for two data elements, then those data elements are not part of the same set of data. For example, if different parent identifiers are re-generated for the first name data element “John” and the last name data element “Smith”, then those data elements are for two different sets of data (e.g., the first data element “John” may be for the set of data for “John Doe” and the second data element may be for the set of data for “Jill Smith”). In particular embodiments, if one parent identifier is re-generated for two data elements, and a second parent identifier is regenerated for another two data elements, then there may be two sets of data that match “John Smith.” For example, the first set of data may be for “John Henry Smith” and the second set of data may be for “John Adam Smith.” In such an example, additional information may be requested from the data requestor to determine which “John Smith” the data requestor would like information for.

At step 316, a child identifier for the date element is re-generated. The child identifier for the data element may be re-generated in any manner. For example, the child identifier for the data element may be re-generated based on the re-generated parent identifier. Furthermore, the child identifier for the data element may be re-generated in a manner similar to that discussed in step 220 of FIG. 2a above (e.g., generation of a child identifier). For example, the child identifier for the data element may be re-generated based on the parent identifier (which was re-generated) and further based on the data element (such as based on the data type of the data element, and/or any other information associated with the data element). For example, if the parent identifier is a 38 character identifier and the data element is a data type of “address”, the child identifier for the data element may be generated based on that 38 character identifier and the “address” data type. In particular embodiments, the parent identifier and the data type (and/or any other information associated with the data element) may be used with the one or more encryption methods 34 to re-generate the child identifier. For example, the parent identifier and the data type may be variables that are plugged into (or otherwise used with) the one or more encryption methods 34. Furthermore, although the re-generated parent identifier may be used to re-generate one or more child identifiers, in particular embodiments, it may not be stored. For example, once the parent identifier is re-generated, it may only be used to re-generate the child identifiers. After this is accomplished, the parent identifier may be overwritten, deleted, or otherwise not stored in the data shredding device 14, the data storage device 42, any of the other components of system 10, or any other location. In particular embodiments, because the parent identifier is not stored, it may not be accessed by any unauthorized attempts (such as a hack or an unauthorized access of the data shredding device 14). As such, the stored data may be more secure.

At step 320, a location number (and/or location name) for the data element is re-generated. The location number (and/or location name) for the data element may be re-generated in any manner. For example, the location number (and/or location name) for the data element may be re-generated in a manner similar to that discussed in step 224 of FIG. 2a above. The location number (and/or location name) for the data element may be re-generated based on the data element (such as the data type of the data element, and/or any other information associated with the data element). For example, if the data element is the data type of “address”, the location number (and/or location name) for the data element may be generated based on the data type of “address”. In particular embodiments, the data type (and/or any other information associated with the data element) may be used with the one or more encryption methods 34 to generate the location number (and/or location name). For example, the data type may be a variable that is plugged into (or otherwise used with) the one or more encryption methods 34. Although the location number (and/or location name) has been described above as being re-generated, in particular embodiments, the location number (and/or location name) may also be retrieved. For example, the data shredding device 14 may transmit a command (such as a SQL command) to the data storage device 42 for the location number (and/or location name) of a location that stores the child identifier. In such an example, the data storage device 42 may search for the results (and re-transmit the results) of such a command by searching for all location numbers (and/or location names) of locations that include the re-generated child identifier, for example.

At step 324, the data element is retrieved. The data element may be retrieved in any manner. For example, one or more commands may be generated for the data element and sent to the data storage device 42. In such an example, following reception of the commands, the data storage device 42 may search for (and re-transmit) the data element based on instructions in the commands. The commands may be any type of command, such as an SQL command, any other command for requesting a data element, or any combination of the preceding. The command (such as an SQL command) may include any type of information. For example, the command may include the re-generated child identifier, the re-generated location number, and/or the location name. Following reception of the command, the data storage device 42 may use the command to search for (and re-transmit) the data element. For example, if the data storage device 42 receives a command that instructs the data storage device 42 to search for and re-transmit the data element having the child identifier “71204287346059177309120113237685743799”, the location name “tblContactAddress_”, and the location number “1354”, the data storage device 42 may search for (and re-transmit) the data element (e.g., the address) having that child identifier and stored in the “tblContactAddress_1354” location.

At step 328, the data element is transmitted for display. The data element may be transmitted to any component and/or device for display. For example, the data element may be transmitted to a display device connected to (or otherwise associated with) the data shredding device 14 (such as a monitor connected to the data shredding device 14). As another example, the data element may be transmitted to a display device connected to (or otherwise associated with) the data access device 54 (such as a monitor connected to the data access device 54). As a result of the transmission of the data element for display, the data requestor may be able to view the requested data element. For example, if the data requestor requested the address associated with the data for John Smith, the data requestor may be able to view the address “123 Someplace Road, Toronto, Ontario, Canada, M1A 1A1” of “John Smith.”

Following transmission of the data element for display, the method 300 may move to step 332 where it is determined whether there are any other requests. If there are more requests, method 300 may move back to step 304, and steps 304-328 may be repeated for each request. If there are not any more requests, method 300 may move to step 336, where method 300 ends.

In particular embodiments, method 300 may allow the stored data elements to be re-assembled into the set of data, such as for view by a data requestor, for example. For example, the steps of method 300 may allow the parent identifier for the set of data to be re-generated. Using this re-generated parent identifier, for example, the data shredding device 14 may be able to re-generate the proper child identifier (and/or the location number and/or location name) for the requested data element, and may be further able to command the data storage device 42 to search for (and re-transmit) the requested data element to the data shredding device 14. As such, if the data requestor requested the address associated with the data for John Smith, the data shredding device 14 may be able to retrieve the address associated with the data for John Smith. In contrast, if the unauthorized user was able to access a first name data element, a last name data element, and an address data element stored in the data storage device 42 (for example), the unauthorized user may access the first name data element of a first set of data, such as for “John Smith”, the last name data element of a second set of data, such as for “Jane Doe”, and the address data element for a third set of data, such as for “Jill Smith”, rendering all of the accessed data unintelligible and useless to the unauthorized user. As such, the stored data may be more secure.

Modifications, additions, or omissions may be made to method 300. For example, although the steps of method 300 are described above as being performed by data shredding device 14, in particular embodiments, one or more of the steps of method 300 may be performed by any other device. As another example, one or more steps of method 300 may be optional, or may not be performed. In particular embodiments, method 300 may be performed without retrieving or re-generating any location numbers (and/or location names). Instead, the requested data element may be retrieved using the child identifier for the data element. Additionally, in particular embodiments, in order to retrieve a child identifier, such as, for example, for the data element “John” and/or data element “Smith”, the parent identifier may be re-generated from the data access/request authentication identifier. This data access/request authentication identifier may be created after successful authentication by data shredding device 14. Furthermore, after the parent identifier is re-generated, the respective child identifiers may be re-generated for the specific data elements. Also, the location number can be re-generated from the parent identifier and the data type element. Additionally, the steps of method 300 may be performed in parallel or in any suitable order. Furthermore, although method 300 has been described above as retrieving a single requested data element for a data set, the method 300 may retrieve any (or all) of the data elements for the data set. For example, the data requestor may have requested all of the information associated with “John Smith”, or any other amount of the information associated with “John Smith” (such as, for example, only the address and telephone number associated with “John Smith”).

Additionally, although the data elements (and/or other information) are described as being stored (and/or transmitted to and/or from the data storage device 42) in an unencrypted manner, the data elements and/or other information may be stored (and/or transmitted to and/or from the data storage device 42) in an encrypted manner. For example, instead of the address associated with the data of “John Smith” being stored (and/or transmitted to and/or from the data storage device 42) as, for example, “123 Someplace Road, Toronto, Ontario, Canada, M1A 1A1”, the address may be stored (and/or transmitted to and/or from the data storage device 42) as, for example, “2J%YLG#B6IAX&Q19JU25SP*2@#HDYQJDM18ST3J9&1”. In such an example, the data shredding device 14 may unencrypt the address after receiving it from the data storage device 42. As another example, instead of the address being stored at the location “tblFirstName_0301”, for example, the address may be stored at the encrypted location name and/or location number of “H1SF8BW45PAQ”. In such an example, the data shredding device 14 may transmit a command to the data storage device 42 for the address data element stored at “H1SF8BW45PAQ”, and the data storage device 42 may search for (and re-transmit) that address data element.

Certain embodiments of the disclosure may provide one or more technical advantages. For example, according to system 10, data to be stored may be shredded into data elements, and each of the data elements may be stored with a respective child identifier. In such an example, although each data element of a set of data may have a child identifier, there may not be any direct relationship between any of the child identifiers. Instead, the parent identifier (which is not stored) may provide the only connection between data elements of the same set of data. As such, even if the data elements are accessed through an unauthorized means (such as by hacking the data storage device 42, for example), the relationship between each of the data elements would remain obscured (e.g., all the hacker will see is scrambled data stored in isolation with no means of putting it all together to make it useful or of value), thereby providing additional security to the stored data. This may provide a computer system (and/or a computerized data storage system) that is more secure, and harder to hack (e.g., hacker resistant), in particular embodiments. Furthermore, this computer system may be capable of protecting the stored data even when an unauthorized user (such as a hacker) is able to break through the firewall or other traditional security systems (e.g., Intrusion Detection Systems/Intrusion Prevention Systems). Additionally, unlike traditional systems, this computer system may further protect the data (and may also allow an authorized user to access the stored data) without storing encryption keys, in particular embodiments. As such, an unauthorized user (such as a hacker) will not be able to improperly access the stored data by merely copying or stealing an encryption key. Also, in particular embodiments, the data elements may be stored in an encrypted manner, which may provide additional security to the stored data.

As another example, according to system 10, a child identifier may be generated for each data element, and the child identifier may uniquely identify the data element. In such an example, each data element may be transmitted for storage with the respective child identifier. Furthermore, the child identifier may operate as an index for the stored data element. As such, the data element may be more easily found in storage and retrieved. Furthermore, as a result of the child identifier uniquely identifying the data element, access time to the data element may be independent of the size of the data storage device or data repository, such as a database. Therefore, the data element may be accessed in substantially the same amount of time, no matter how many data elements are added to data storage device. In particular embodiments, this may allow for additional storage without requiring search times to be increased. As such, the computer system may be a high-speed computer system that may run faster (and retrieve stored data faster) even when larger amounts of data are stored. Additionally, due to this ability to run faster (and retrieve stored data faster), the computer system may not require as many hardware resources in order to enhance performance. Furthermore, in particular embodiments, because the child identifier is generated automatically for the data element, and may operate as an index for the data elements, the child identifiers may reduce the need for administration time to upkeep the index of the data storage device. Specifically, the ability of the child identifiers to operate as an index may cause the index to be continuously updated, and further cause the computer system to be less prone to index failures, in particular embodiments. As such, this computer system may need less administration time (or have less administration needs) due to less index failures.

As used herein, a “computer” or “computer system” may be, for example, and without limitation, either alone or in combination, a personal computer (PC), server-based computer, main frame, server, microcomputer, minicomputer, laptop, personal data assistant (PDA), cellular phone, pager, processor, including wireless and/or wire line varieties thereof, and/or any other computerized device capable of configuration for receiving, storing and/or processing data for standalone application and/or over a networked medium or media.

Computers and computer systems described herein may include operatively associated computer readable memory media such as memory for storing software applications and instructions used in obtaining, processing, storing, and/or communication data. It can be appreciated that such memory can be internal, external, remote, or local with respect to its operatively associated computer or computer system. Memory may also include any means for storing software or other instructions, including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer readable media.

In general, computer readable memory media may include any non-transitory memory medium capable of being a memory for electronic data representative of data or computer instructions stored, communicated, or processed in accordance with embodiments of the present invention. Where applicable, method steps described herein may be embodied or executed as computer instructions stored on a computer readable memory medium or media.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or reorganizing any of the disclosed steps, components, elements, features, aspects, characteristics, limitations, and the like, of the various non-limiting and non-exhaustive embodiments described in this specification. In this manner, Applicant reserves the right to amend the claims during prosecution to add features as variously described in this specification, and such amendments comply with the requirements of 35 U.S.C. §§112(a) and 132(a).

1. A computer system, comprising:
one or more memory units configured to store one or more instructions; and
one or more programmable processors coupled to the memory units and configured, upon executing the one or more instructions, to:
receive a first set of data;
generate a parent identifier for the first set of data, the parent identifier being a unique identifier for the first set of data;
shred the first set of data into a plurality of data elements, the plurality of data elements including a first data element and a second data element;
generate a first child identifier for the first data element, the first child identifier being a unique identifier for the first data element, the first child identifier being generated based on the parent identifier and the first data element;
generate a first location number for the first data element, the first location number being generated based on the first data element; and
transmit the first data element and the first child identifier for storage in a first database in a first location having the first location number.

2. The computer system of claim 1, wherein the one or more programmable processors are further configured, upon executing the one or more instructions, to:
generate a second child identifier for the second data element, the second child identifier being a unique identifier for the second data element, the second child identifier being generated based on the parent identifier and the second data element;
generate a second location number for the second data element, the second location number being generated based on the second data element; and
transmit the second data element and the second child identifier for storage in the first database in a second location having the second location number.

3. The computer system of claim 1, wherein the one or more programmable processors are further configured, upon executing the one or more instructions, to:
generate a second child identifier for the second data element, the second child identifier being a unique identifier for the second data element, the second child identifier being generated based on the parent identifier and the second data element;
generate a second location number for the second data element, the second location number being generated based on the second data element; and
transmit the second data element and the second child identifier for storage in a second database in a second location having the second location number.

4. The computer system of claim 1, wherein:
the first set of data comprises a first name of a person, a last name of the person, an address of the person, and a phone number of the person;
the plurality of data elements further include a third data element and a fourth data element;
the first data element comprises the first name of the person;
the second data element comprises the last name of the person;
the third data element comprises the address of the person; and
the fourth data element comprises the phone number of the person.

5. The computer system of claim 1, wherein:
the first set of data comprises credit card information of a person;
the first data element comprises a first portion of the credit card information of the person; and
the second data element comprises a second portion of the credit card information of the person.

6. The computer system of claim 1, wherein the parent identifier is not stored.

7. The computer system of claim 1, wherein the one or more programmable processors are further configured, upon executing the one or more instructions, to:
receive a request for the first data element of the first set of data;
based on the request, retrieve one or more child identifiers associated with the first set of data;
based on the one or more child identifiers associated with the first set of data, re-generate the parent identifier for the first set of data;
based on the parent identifier for the first set of data, re-generate the first child identifier for the first data element;
based at least on the first child identifier for the data element, retrieve the first data element; and
transmit the first data element for display.

8. A tangible computer readable medium comprising logic configured, when executed by one or more programmable processors, to:
receive a first set of data;
generate a parent identifier for the first set of data, the parent identifier being a unique identifier for the first set of data;
shred the first set of data into a plurality of data elements, the plurality of data elements including a first data element and a second data element;
generate a first child identifier for the first data element, the first child identifier being a unique identifier for the first data element, the first child identifier being generated based on the parent identifier and the first data element;
generate a first location number for the first data element, the first location number being generated based on the first data element; and
transmit the first data element and the first child identifier for storage in a first database in a first location having the first location number.

9. The tangible computer readable medium of claim 8, wherein the logic is further configured, when executed by the one or more programmable processors, to:
generate a second child identifier for the second data element, the second child identifier being a unique identifier for the second data element, the second child identifier being generated based on the parent identifier and the second data element;
generate a second location number for the second data element, the second location number being generated based on the second data element; and
transmit the second data element and the second child identifier for storage in the first database in a second location having the second location number.

10. The tangible computer readable medium of claim 8, wherein the logic is further configured, when executed by the one or more programmable processors, to:
generate a second child identifier for the second data element, the second child identifier being a unique identifier for the second data element, the second child identifier being generated based on the parent identifier and the second data element;
generate a second location number for the second data element, the second location number being generated based on the second data element; and
transmit the second data element and the second child identifier for storage in a second database in a second location having the second location number.

11. The tangible computer readable medium of claim 8, wherein:
the first set of data comprises a first name of a person, a last name of the person, an address of the person, and a phone number of the person;
the plurality of data elements further include a third data element and a fourth data element;
the first data element comprises the first name of the person;
the second data element comprises the last name of the person;
the third data element comprises the address of the person; and
the fourth data element comprises the phone number of the person.

12. The tangible computer readable medium of claim 8, wherein:
the first set of data comprises credit card information of a person;
the first data element comprises a first portion of the credit card information of the person; and
the second data element comprises a second portion of the credit card information of the person.

13. The tangible computer readable medium of claim 8, wherein the parent identifier is not stored.

14. The tangible computer readable medium of claim 8, wherein the logic is further configured, when executed by the one or more programmable processors, to:
receive a request for the first data element of the first set of data;
based on the request, retrieve one or more child identifiers associated with the first set of data;
based on the one or more child identifiers associated with the first set of data, re-generate the parent identifier for the first set of data;
based on the parent identifier for the first set of data, re-generate the first child identifier for the first data element;
based at least on the first child identifier for the data element, retrieve the first data element; and
transmit the first data element for display.

15. A method, comprising:
receiving, by one or more programmable processors, a first set of data;
generating, by the one or more programmable processors, a parent identifier for the first set of data, the parent identifier being a unique identifier for the first set of data;
shredding, by the one or more programmable processors, the first set of data into a plurality of data elements, the plurality of data elements including a first data element and a second data element;
generating, by the one or more programmable processors, a first child identifier for the first data element, the first child identifier being a unique identifier for the first data element, the first child identifier being generated based on the parent identifier and the first data element;
generating, by the one or more programmable processors, a first location number for the first data element, the first location number being generated based on the first data element; and
transmitting, by the one or more programmable processors, the first data element and the first child identifier for storage in a first database in a first location having the first location number.

16. The method of claim 15, further comprising:
generating, by the one or more programmable processors, a second child identifier for the second data element, the second child identifier being a unique identifier for the second data element, the second child identifier being generated based on the parent identifier and the second data element;
generating, by the one or more programmable processors, a second location number for the second data element, the second location number being generated based on the second data element; and
transmitting, by the one or more programmable processors, the second data element and the second child identifier for storage in the first database in a second location having the second location number.

17. The method of claim 15, further comprising:
generating, by the one or more programmable processors, a second child identifier for the second data element, the second child identifier being a unique identifier for the second data element, the second child identifier being generated based on the parent identifier and the second data element;
generating, by the one or more programmable processors, a second location number for the second data element, the second location number being generated based on the second data element; and
transmitting, by the one or more programmable processors, the second data element and the second child identifier for storage in a second database in a second location having the second location number.

18. The method of claim 15, wherein:
the first set of data comprises a first name of a person, a last name of the person, an address of the person, and a phone number of the person;
the plurality of data elements further include a third data element and a fourth data element;
the first data element comprises the first name of the person;
the second data element comprises the last name of the person;
the third data element comprises the address of the person; and
the fourth data element comprises the phone number of the person.

19. The method of claim 15, wherein:
the first set of data comprises credit card information of a person;
the first data element comprises a first portion of the credit card information of the person; and
the second data element comprises a second portion of the credit card information of the person.

20. The method of claim 15, wherein the parent identifier is not stored.

21. The method of claim 15, further comprising:
receiving, by the one or more programmable processors, a request for the first data element of the first set of data;
based on the request, retrieving, by the one or more programmable processors, one or more child identifiers associated with the first set of data;
based on the one or more child identifiers associated with the first set of data, re-generating, by the one or more programmable processors, the parent identifier for the first set of data;
based on the parent identifier for the first set of data, re-generating, by the one or more programmable processors, the first child identifier for the first data element;
based at least on the first child identifier for the data element, retrieving, by the one or more programmable processors, the first data element; and
transmitting, by the one or more programmable processors, the first data element for display.
